(19) United States
(12) Patent Application Publication
(10) Pub. No.: US 2004/0183288 A1
(43) Pub. Date: Sep. 23, 2004

(54) Driver's gas bag module

(75) Inventors: Kadri Aygun, Aschaffenburg (DE); Stefan Bohn, Goldbach (DE); Lutz Haese, Aschaffenburg (DE); Andreas Deisel, Rollbach (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/767,634

(22) Filed: Jan. 29, 2004

(30) Foreign Application Priority Data
Jan. 31, 2003 (DE) 203 01 521.5

(51) Int. Cl. B60R 21/16

(52) U.S. Cl. 280/731; 280/743.1

(57) ABSTRACT

A driver's gas bag module includes a gas bag (18) which in relation to an inflated state has a front wall (22) facing a driver (A), a central section (24) of the front wall in the inflated state having an indentation (26). The indentation is created by the central section (24) at least partially being prevented from a movement in the direction out from the gas bag module (10). The front wall (22), in relation to the center (28) of the indentation (26), has an upper region (30) and a lower region (32), an outer edge (36) of the upper region (30) having three substantially straight sections (36a, 36b, 36c).

### TECHNICAL FIELD

The invention relates to a driver's gas bag module.

### BACKGROUND OF THE INVENTION

There are prior art driver's gas bag modules comprising a gas bag which in relation to the inflated state has a front wall facing the driver, the central section of the front wall in the inflated state having an indentation, the latter being created by the central section at least partially being prevented from a movement in the direction out from the gas bag module.

In such gas bag modules, which are known for example from EP-A-1 115 926, the gas bag is usually ring-shaped. The front wall here is the wall of the gas bag which in the inflated state is directed to the driver and onto which the driver can strike. The central section is usually the center of the front wall which at least at the start of the unfolding remains fastened to the gas bag module, so that in the inflated state the already mentioned ring shape of the gas bag is formed. Owing to this ring shape, the gas bag emerges obliquely outwards from the module housed in the steering wheel of the vehicle; only subsequently does the front wall move in the direction towards the driver.

Also for the case of a premature striking of the driver onto the gas bag which is still unfolding, or where the unfolding is affected by an obstacle, an optimum protective effect for the driver is aimed for. In conventional gas bag modules with a ring-shaped gas bag, a selected unfolding is assisted by a costly pre-folding of the gas bag.

The invention provides a driver's gas bag module which can be produced more simply and at a more favorable cost, in which also an improved protection for the driver is achieved under non-optimum unfolding conditions.

### BRIEF SUMMARY OF THE INVENTION

According to the invention, a driver's gas bag module includes a gas bag which in relation to an inflated state has a front wall facing a driver, a central section of the front wall in the inflated state having an indentation. The indentation is created by the central section at least partially being prevented from a movement in the direction out from the gas bag module. The front wall, in relation to the center of the indentation, has an upper region and a lower region, an outer edge of the upper region having three substantially straight sections. In contrast to the usual ring shape of the gas bag in generic driver's gas bag modules, the invention provides a “cornered” contour of the upper region of the front wall of the gas bag, which assists a supporting of the gas bag on the rim of the steering wheel of the vehicle during unfolding. Through the particular geometry of the upper region, therefore a possible dislocation of the gas bag to behind the steering wheel rim under unfavorable conditions during unfolding is avoided, without a prefolding of the gas bag being necessary. The elimination of prefolding generally leads to a greater process security on manufacture of the gas bag module. In addition, the cycle time can be shortened during the folding process of the gas bag.

Advantageous developments of the driver's gas bag module according to the invention are indicated in the sub-claims.

### BRIEF DESCRIPTION OF THE DRAWINGS

FIG. 1a shows a side view of a driver's gas bag module according to the invention with inflated gas bag in accordance with a first embodiment;

FIG. 1b shows a top view onto the driver's gas bag module of FIG. 1a; and

FIG. 2 shows a top view onto a driver's gas bag module according to the invention with inflated gas bag in accordance with a second embodiment.

### DETAILED DESCRIPTION OF THE PREFERRED EMBODIMENTS

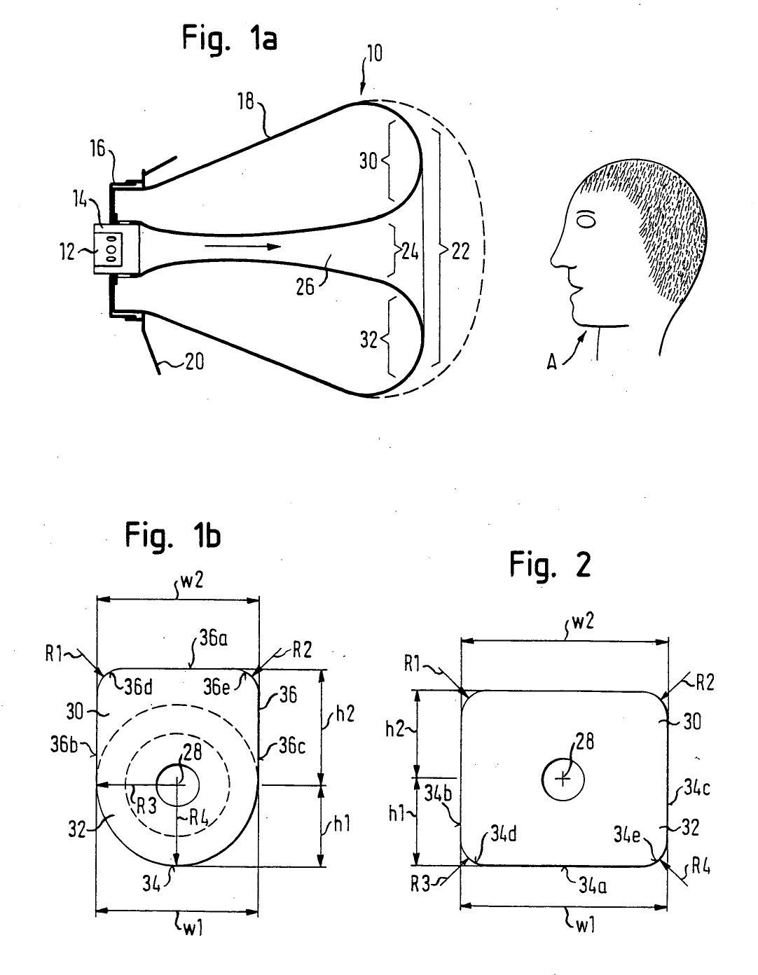

The gas bag module 10 illustrated in FIG. 1 a is housed in the steering wheel of a vehicle. The gas bag module 10 has a gas generator 12 around which a holding part in the form of a diffusor 14 is arranged. The diffusor 14, together with the gas generator 12, is in turn secured to the housing 16 of the gas bag module 10. Between the diffusor 14 and the outer wall of the housing, an annular space is formed in which a gas bag 18 is housed, which is folded together without being prefolded. A covering flap 20 closes the gas bag module 10 in the non-unfolded state of the gas bag 18 and is swiveled outwards during the unfolding.

The gas bag 18 consists of a gas bag wall which has several sections, inter alia a section which is designated as front wall 22. The front wall 22 is the part of the gas bag 18 which faces the driver A. The front wall 22 has a centrical section, hereinafter named the central section 24, which runs inwards in the direction towards the diffusor 14, i.e. is directed into the interior of the gas bag 18, so that an indentation 26 is produced.

The top view of the gas bag module 10 illustrated in FIG. 1b shows the shape of the gas bag 18 from the view of the driver A. The front wall 22 can be divided into a region above the center 28 of the indentation 26 (upper region 30) and a region below the center 28 (lower region 32), the lower region 32 having a shape different from that of the upper region 30. Whereas the lower region 32 has substantially the form of a ring section with a round outer edge 34, the outer edge 36 of the upper region 30 has three substantially straight sections 36a, 36b, 36c connected by two curved transition sections 36d, 36e. The radii R1, R2 of the curved transition sections 36d, 36e are substantially smaller than the radii R3, R4, which determine the curvature of the outer edge 34 of the lower region 32, and therefore substantially smaller than the distance of the curved transition sections 36d, 36e from the center 28 of the indentation 26. Thereby, the upper region 30 of the front wall 22 is given a comparatively “cornered” shape.

In the embodiment of FIGS. 1a and 1b illustrated by way of example, the horizontal width w1 (transverse to the longitudinal direction of the vehicle) of the lower region 32 is equal to the width w2 of the upper region 30, and the vertical height h1 of the lower region 32 is smaller than the height h2 of the upper region 30. In alternative embodiments, however, the width w2 of the upper region can be greater than the width w1 of the lower region and/or the heights h1, h2 of the two regions 30, 32 can be equal.

The embodiment shown in FIG. 2 differs from the previously described embodiment in that also the lower region 32 has a “cornered” shape, so that as a whole a rectangular shape of the front wall 22 is produced. The outer edge 34 of the lower region 32 can be divided, in an analogous manner to the outer edge 36 of the upper region 30, into three substantially straight sections 34a, 34b, 34c and two curved transition sections 34d, 34e with radii of curvature R3 and R4, respectively.

The two illustrated embodiments have in common the fact that in particular the “cornered” upper region 30 of the front wall 22 assists a supporting of the gas bag 18 on the steering wheel rim during unfolding and therefore prevents a dislocation thereof to behind the steering wheel rim.

1. A driver's gas bag module comprising a gas bag (18), said gas bag in relation to an inflated state having a front wall (22) facing a driver (A), a central section (24) of said front wall in said inflated state having an indentation (26), said indentation being created by said central section (24) at least partially being prevented from a movement in a direction out from said gas bag module (10), characterized in that said front wall (22), in relation to a center (28) of said indentation (26), has an upper region (30) and a lower region (32), an outer edge (36) of said upper region (30) having three substantially straight sections (36a, 36b, 36c).

2. The driver's gas bag module according to claim 1, characterized in that said three straight sections (36a, 36b, 36c) of said outer edge (36) of said upper region (30) are connected with each other by curved transition sections (36d, 36e), the latter having radii (R1, R2) which are substantially smaller than a distance thereof from said center (28) of said indentation (26).

3. The driver's gas bag module according to claim 1, characterized in that a horizontal width (w2) of said upper region (30) is greater than a horizontal width (w1) of said lower region (32).

4. The driver's gas bag module according to claim 1, characterized in that a horizontal width (w2) of said upper region (30) is equal to a horizontal width (w1) of said lower region (32).

5. The driver's gas bag module according to claim 1, characterized in that a vertical height (h2) of said upper region (30) is greater than a vertical height (h1) of said lower region (32).

6. The driver's gas bag module according to claim 1, characterized in that a vertical height (h2) of said upper region (30) is equal to a vertical height (h1) of said lower region (32).

7. The driver's gas bag module according to claim 1, characterized in that said outer edge (34) of said lower region (32) has a continuous curvature which is defined by at least one radius (R3, R4) substantially corresponding to a distance of said outer edge (34) from said center (28) of said indentation (26).

8. The driver's gas bag module according to claim 1, characterized in that also an outer edge (34) of said lower region (32) has three substantially straight sections (34a, 34b, 34c).

9. The driver's gas bag module according to claim 8, characterized in that said three straight sections (34a, 34b, 34c) of said lower region (32) are connected with each other by curved transition sections (34d, 34e), the latter having radii (R3, R4) which are substantially smaller than a distance thereof from said center (28) of said indentation (26).
